(19) United States
(12) Patent Application Publication
(10) Pub. No.: US 2004/0091757 A1
(43) Pub. Date: May 13, 2004

(54) Implantable fuel cell

(76) Inventors: Xingwu Wang, Wellsville, NY (US); Chaonan Chen, Alfred Station, NY (US); Huihui Duan, Alfred Station, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 10/035,985

(22) Filed: Dec. 31, 2001

(51) Int. Cl. H01M 8/06; H01M 4/86

(52) U.S. Cl. 429/19; 429/43

(57) ABSTRACT

An implantable fuel cell assembly containing a device for converting fat to glycerol and fatty acid, a device for converting glycerol to hydrogen, a device for converting fatty acid to hydrogen, a device for converting a bodily fluid to a gas selected from the group consisting of hydrogen, oxygen, and mixtures thereof, and a fuel cell for producing electricity from hydrogen and oxygen.

### FIELD OF THE INVENTION

An implantable biochemical fuel cell which consumes body fat as it produces electricity.

### BACKGROUND OF THE INVENTION

Implantable fuel cells are well known to the art and have been described as early as 1973.

In 1973, in U.S. Pat. No. 3,774,243, Daniel Ng et al. disclosed an implantable hybrid power system comprised of a storage battery and a fuel cell.

In 1974, in U.S. Pat. No. 3,837,339, Sol Aisenberg et al. disclosed a glucose diffusion limited fuel cell. The device of this patent included telemetry means communicating with an external receiver.

In 1974, in U.S. Pat. No. 3,837,922, Daniel Ng et al. disclosed an implantable fuel cell power source which utilized blood carbohydrates as the anode fuel. In one embodiment, the cathode of the fuel cell was an oxygen-utilizing cathode that was ventilated through a percutaneous airway by a balloon system.

In 1975, in U.S. Pat. No. 3,861,397, Raghavendra Rao et al. disclosed an implantable fuel cell in which “. . . a fuel cell electrode as well as one or several selective oxygen electrodes are spatially so arranged with respect to each other that the operational mixture diffused in operational condition form the body liquid into the cell is guided substantially initially to the corresponding oxygen electrodes . . . .”

In 1979, in U.S. Pat. No. 4,140,963, Raghavendara Rao et al. disclosed an electrochemical glucose cell that was used to produce an electrical signal corresponding to the sugar concentration in a living organism.

In 1981, in U.S. Pat. No. 4,294,891, Shang J. Yao et al. disclosed an implantable fuel cell that was intermittently refuelable through one or more percutaneously positioned refueling ports.

In September of 2001, in U.S. Pat. No. 6,294,281 of Adam Heller, a fuel cell was disclosed with anode enzyme disposed on the anode and cathode enzyme disposed on the cathode. In column 1 of this patent, it is disclosed that “Fuel cells that operate using organic compounds have not been developed, at least in part, because the surfaces of the electrocatalysts for the oxidation of the organic compounds have not been stabilized. Fouling by intermediate oxidation products, that are strongly bound to the active sites of the catalysts, causes loss of electrocatalyst activity.”

The Heller patent, although an improvement upon prior art fuel cells devices, does not disclose how the fuel cell can continually be supplied with the fuel it requires. Thus, e.g., Heller discloses at Column 12 that “. . . one or more sugars, alcohols, and/or carboxylic acids, typically found in the biological system, are electrooxidized . . . .” (see lines 42-44 of Column 12). However, Heller does not disclose how such “. . . sugars, alcohols, and/or carboxylic acids . . . ” are continually provided to his fuel cell to enable it to operate.

It is an object of this invention to provide an implantable fuel cell which is substantially superior to the fuel cell assembly of U.S. Pat. No. 6,294,281.

### SUMMARY OF THE INVENTION

In accordance with this invention, there is provided an implantable fuel cell assembly comprised of means for converting fat to glycerol and fatty acid, means for converting glycerol to hydrogen, means for converting fatty acid to hydrogen, means for converting a bodily fluid to a gas selected from the group consisting of hydrogen, oxygen, and mixtures thereof, and fuel cell means for producing electricity from hydrogen and oxygen.

### BRIEF DESCRIPTION OF THE DRAWINGS

The invention will be described by reference to the following drawings, in which like numerals refer to like elements, and in which:

FIG. 1 is a schematic of one preferred implantable fuel cell assembly of the invention;

FIG. 1A is a schematic off one preferred means for harvesting fat to be used in the fuel cell assembly of this invention;

FIG. 2 is a flow diagram illustrating one preferred process of the invention;

FIG. 3 is a schematic of one preferred fuel cell used in the assembly of this invention;

FIGS. 4A and 4B are side and front views of one preferred means for utilizing the fuel cell assembly of this invention;

FIG. 5 is a schematic of one preferred means for storing, converting, and/or delivering the energy produced by the fuel cell assembly of this invention;

FIG. 6 is an electrical schematic which may be utilized in the assembly of FIG. 7; and

FIG. 7 is an electrical schematic of a circuit which can utilize the fuel cell assembly of this invention.

### DESCRIPTION OF THE PREFERRED EMBODIMENTS

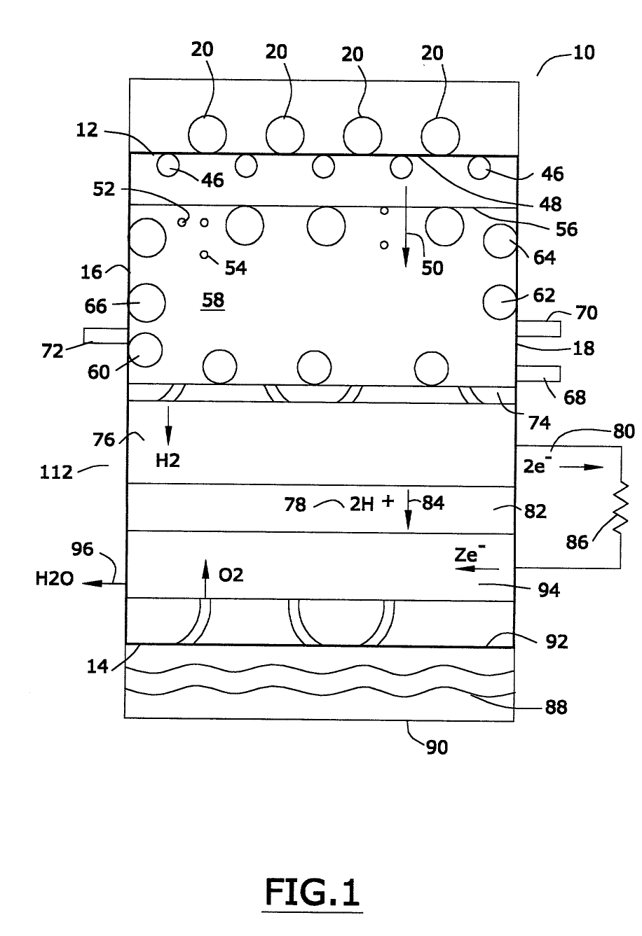

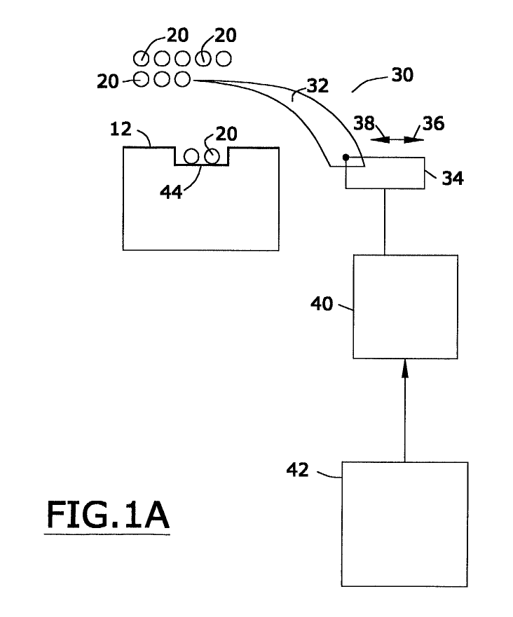

FIG. 1 is a schematic diagram of a preferred fuel cell assembly 10. In the embodiment depicted in FIG. 1, fuel cell assembly 10 is comprised of walls 12, 14, 16 and 18.

The fuel cell assembly 10 is preferably an implantable fuel cell assembly that, in one embodiment, is disposed in a living organism next to or near fat cells 20. As is known to those skilled in the art, such fat cells 20 are very prevalent in many parts of the human body. Thus, for example, fat tissue is prevalent underneath the skin of human beings, percutaneously.

Means for disposing a device percutaneously are well known to those skilled in the art. Reference may be had, e.g., to U.S. Pat. No. 3,837,922, the entire disclosure of which is hereby incorporated by reference into this specification; thus, e.g., this patent discloses an claims “. . . a percutaneous airway adapted to communicate with the exterior of said body via an unhindered pore . . . ” Reference also may be had to U.S. Pat. No. 6,299,930 (percutaneous biofixed medical implants), U.S. Pat. No. 6,249,707 (percutaneous implanted device), U.S. Pat. No. 5,990,380 (percutaneous biofixed medical implant), U.S. Pat. No. 5,782,645 (percutaneous connector), U.S. Pat. No. 5,607,465 (percutaneous implantable valve), U.S. Pat. No. 4,946,444, and the like. The entire disclosure of each of these United States patents is hereby incorporated by reference into this specification.

Referring again to FIG. 1, and in the preferred embodiment depicted therein, the fuel cell assembly 10 is contiguous with or near fat cells 20. These fat cells are preferably treated so that have an average particle size of less than about 100 microns prior to the time they permeate through the wall 12.

One may use any conventional means for harvesting the bodily fat cells to produce the desired particle size. In one embodiment, the implantable apparatus described in FIG. 1A is used.

Referring to FIG. 1A, and in the preferred embodiment depicted therein, the harvester 30 is comprised of a microknife 32 which, in the embodiment depicted, is caused to move in several directions by oscillator 34, which itself moves in the directions of arrows 36 and 38. The oscillator 34 is connected to a driver 40 which, in turn is connected to a power supply 42.

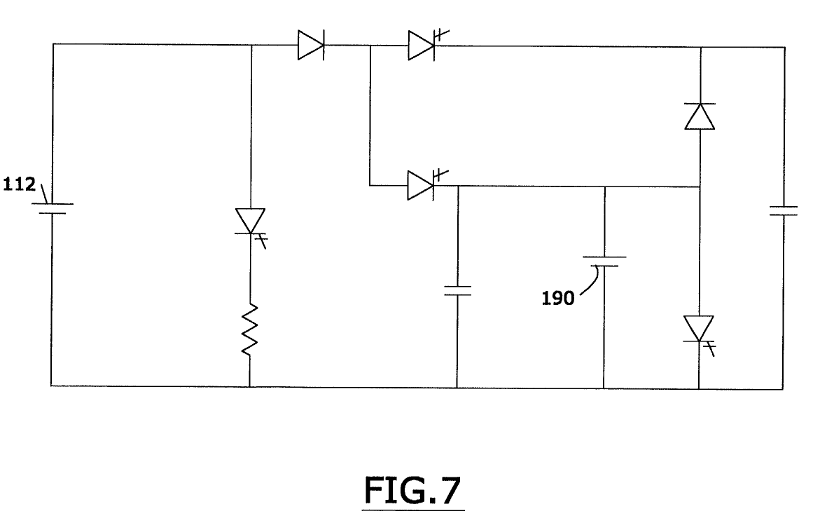

The power supply 42 may be, e.g., the power supply illustrated in FIGS. 7 and 8. Alternatively, or additionally, one may use other sources of power such as, e.g., implantable electrostrictive material, implanted piezoelectric material, implanted microelectrical mechanical systems (MEMS), and the like.

In one embodiment, depicted in FIG. 1A, the fat cells 20 dislodged by knife 32 are allowed to fall into an orifice 44 of the wall 12 (see FIG. 1). It is preferred that the wall 12 be comprised of a multiplicity of such orifices 44.

Referring again to FIG. 1A, the wall 12 and the indentation(s) 44 have a porosity such that the dislodged fat cells 20 readily pass through such wall 12. In one embodiment, the wall 12 is comprised of a fat-permeable material.

By way of illustration and not limitation, one may use the fat permeable material disclosed in U.S. Pat. No. 6,152,025, the entire disclosure of which is hereby incorporated by reference into this specification. This patent discloses a structure and method is provided for absorbing excess fat from an environment including one or more fats insolubly combined in an aqueous solution mix. The structure includes a plurality of layers, at least one of which is formed from a preferentially fat-permeable, oleophilic material having a greater affinity for fat than for the aqueous solution. Preferably, the structure includes particular structural and topographic components that effectively enhance the inherent fat-affinity of the oleophilic material.

Referring again to FIG. 1, and in the preferred embodiment depicted therein, the dislodged fat cells that pass through wall 12 are contacted with one or more lipase enzymes 46. As is known to those skilled in the art, lipase enzymes catalyze the hydrolysis of fats to glycerol and fatty acids. These enzymes are well known to those skilled in the art. Reference may be had, e.g., to U.S. Pat. No. 5,681,715 (process for preparing lipases), U.S. Pat. No. 5,968,792 (activation of lipase enzymes), U.S. Pat. No. 4,839,287 (transesterification of triglycerides), U.S. Pat. Nos. 4,264,868, 4,275,081 (water-soluble microbial lipases), and the like. The entire disclosure of each of these United States patents is hereby incorporated by reference into this specification.

The concentration of lipase enzymes 46 used beneath wall 12 will depend, at least in part, upon the rate of hydrogen production desired; and the rate of hydrogen production, in turn, will dictate the rate of power production. In one embodiment, from about 3 to about 10 percent (by total mass of enzyme and fat) of the enzyme 46 should be present within the assembly 10. In general, the lipase enzyme particles are preferably contiguous with the inner surface 48 of wall 12 but preferably are sufficiently spaced from each other so that the fat particles and/or the glycerol and/or fatty acids pass in the direction of arrow 50.

Referring again to FIG. 1, the glycerol 52 and the fatty acid(s) 54 formed from the lipid particles 20 then tend to flow in the direction of arrow 50, primarily because of the concentration differential across the wall 56. The wall 56 preferably is permeable to the glycerol and the fatty acid(s) but not to the lipid molecules 20 and/or the lipase enzyme46. The wall 56 preferably has an average pore size less than about 10 nanometers.

As is known to those skilled in the art, glycerol is a three-carbon trihydroxy alcohol. Fatty acids are long chain carboxylic acids that occur in lipids, and they may be branched or unbranched, saturated or unsaturated. Reference may be had, e.g., to U.S. Pat. Nos. 4,853,038, 4,011,251, 5,932,458, 5,917,068, 5,089,403, and the like. The entire disclosure of each of these United States patents is hereby incorporated by reference into this specification.

Referring again to FIG. 1, and in the preferred embodiment depicted therein, the glycerol material 52 and the fatty acid material 54 pass conversion chamber 58, in which the fatty acid(s) are converted to hydrogen and carbon dioxide. Disposed within the conversion chamber 58 are enzymes 60, 62, 64, and 66 which promote the beta oxidation of fatty acids and other reactions. As is known to those skilled in the art, beta oxidation is the oxidation of fatty acids through successive cycles of reactions, with each operation of the cycle leading to a shortening of the fatty acid by a two-carbon fragment that is removed in the form of acetyl coenzyme A. Reference may be had, e.g., to U.S. Pat. Nos. 6,245,317, 6,160,138, 6,121,299, 5,057,301, and the like. The entire disclosure of each of these United States patents is hereby incorporated by reference into this specification.

One may dispose one or more beta-oxidase enzymes within the conversion chamber 58, as enzymes 60. Such beta-oxidases may include, e.g., fatty acid CoA synthetase, fatty acyl CoA dehydrogenases, encyl CoA hydrases, beta-hydroxyacyl CoA dehydrogenases, beta-ketoacyl CoA thiolases, and the like.

The beta-oxidation of the fatty acids produces acetyl coenzyme A. As is known to those skilled in the art, acetyl coenzyme A is the acylated form of coenzyme A, and it is a key intermediate in the citric acid cycle. Reference may be had, e.g., to U.S. Pat. Nos. 6,329,208, 6,277,842, 5,597,548, 5,413,917, 5,475,031, 5,302,520, and the like. The entire disclosure of each of these United States patents is hereby incorporated by reference into this specification.

In one preferred embodiment, the citric acid cycle is allowed to occur within chamber 58. The acetyl coenzyme A is fed into the cycle (from the conversion of fatty acid by the beta oxidases), and carbon dioxide is removed from the cycle via port 68. Alternatively, or additionally, other byproduct(s) may be exhausted via port 68.

In addition to the beta-oxidase enzymes, one may utilize other enzymes in the system. One may feed the glycerol formed within chamber 48 to the living organism via port 70. Alternatively, one may feed such glycerol to a glycerol fuel cell (not shown) via port 72.

In one embodiment, the glycerol fuel cell utilized is described and claimed in U.S. Pat. No. 4,294,891 of Shang J. Yao, the entire disclosure of which is hereby incorporated by reference into this specification. This patent describes a biologically acceptable, implantable, bio-oxidant fuel cell comprising in operative combination: (a) at least one anode assembly; (b) at least one cathode assembly; (c) a fuel/electrolyte chamber defined between said anode and said cathode assemblies for receiving an externally supplied fuel; (d) an electrical lead attached to each of said anode and cathode assembly to provide electrical output to a prosthesis; (e) a biologically acceptable, oxygen permeable membrane disposed substantially in contact with said cathode assembly so that said membrane lies between said cathode and body tissue, said membrane being adapted to permit endogenous tissue O2 as a biological oxidant to diffuse into said cell from said body tissue; a (D fuel/electrolyte composition disposed in said fuel/electrolyte chamber; and (g) said fuel/electrolyte composition having a high concentration ratio of fuel to endogenous tissue O2 diffusing through a device. By way of further illustration, one may use the glycerol fuel cell disclosed in U.S. Pat. No. 6,294,281, the entire disclosure of which is hereby incorporated by reference into this specification. This patent discloses and claims a fuel cell comprising an anode; anode enzyme disposed on the anode, the anode being configured and arranged for electroxidizing an anode reductant in the presence of the anode enzyme; a cathode spaced apart from the anode; and cathode enzyme disposed on the anode, the cathode being configured and arranged for electroreducing a cathode oxidant in the presence of the cathode enzyme.

Referring again to FIG. 1, in one embodiment some or all of the glycerol is converted within chamber 58 to hydrogen by conventional means.

Referring again to FIG. 1, the hydrogen produced from the breakdown of the fatty acid(s) and/or the breakdown of glycerol and/or from the glycerol fuel cell is passed through hydrogen permeable membrane 74 until it contacts anode 76. The anode 76 preferably consists of a porous, conductive material.

It is preferred that the anode 76 be similar to or identical to the anodes used in proton exchange membrane (PEM) fuel cells. These fuel cells, and the electrodes they utilize, are well known to those skilled in the art. Reference may be had, e.g., to U.S. Pat. Nos 6,309,773, 6,277,513 (layered electrode assembly), U.S. Pat. Nos. 6,190,791, 6,110,611, 6,063,516, 6,020,083 (membrane electrode assembly), U.S. Pat. Nos. 6,010,798, 5,952,118, and the like The entire disclosure of each of these United States patents is hereby incorporated by reference into this specification.

In one embodiment, and as is disclosed in U.S. Pat. No. 6,294,281, the anode 76 has anode enzyme disposed on such anode. This anode enzyme may be, e.g., an oxidase, a dehydrogenase, etc.

Referring again to FIG. 1, the anode 76 converts hydrogen into two hydrogen ions 78 and two electrons 80. The fuel cell electrolyte 82 facilitates the transmission of the hydrogen ions 78 in the direction of arrow 84. Simultaneously, electrons 80 pass through load 86, doing work. The load 86 may be one or more of the fat harvester 30, a pacemaker (not shown), an artificial heart (not shown). Alternatively, or additionally, the load 86 may be the input to one or more of the power supplies described elsewhere in this specification.

Referring again to FIG. 1, wall 14 of fuel cell assembly 10 is preferably disposed near a bodily fluid, such as the blood 88 within blood vessel 90. The wall 14 preferably is comprised of or consists of an oxygen permeable membrane 92 which allows the flow of oxygen into cathode 94.

One may use conventional means for selectively allowing the flow of oxygen into cathode 94. Thus, e.g., one may use the device and process disclosed in U.S. Pat. No. 4,294,891, the entire disclosure of which is hereby incorporated by reference into this specification.

In one embodiment, hydrogen peroxide present within a patient's bodily fluid(s) is converted to waiter and oxygen. As will be apparent, in addition to providing oxygen for the fuel cell 112, this embodiment also reduces the level of harmful oxidizing agent within the body.

U.S. Pat. No. 4,294,891 discloses an assembly coated with a medical grade silicone rubber such as, e.g., medical adhesive silicone type A silicone elastomer “SILASTIC” brand made by Dow Corning, or an RTV of silicone rubber made by General Electric Corporation. Any coating material which is biocompatible, nonreactive, tissue acceptable, and permitting oxygen diffusivity therethrough may be used in the device of such patent; such material must prevent the diffusion outwardly from the electrolyte chambers of such patent of either the electrolyte/fuel solution or any toxic oxidation/reduction product.

Referring again to FIG. 1, the oxygen within cathode 94 recombines with the two hydrogen ions 78 to form water. The water thus formed may be exhausted through line 96.

The cathode 94 preferably is a porous, conductive cathode such as is typically found in the proton exchange membrane fuel cells referred to in U.S. Pat. Nos. 6,309,773, 6,277,513 (layered electrode assembly), U.S. Pat. Nos. 6,190,791, 6,110,611, 6,063,516, 6,020,083 (membrane electrode assembly), U.S. Pat. No. 6,010,798, 5,952,118, and the like.

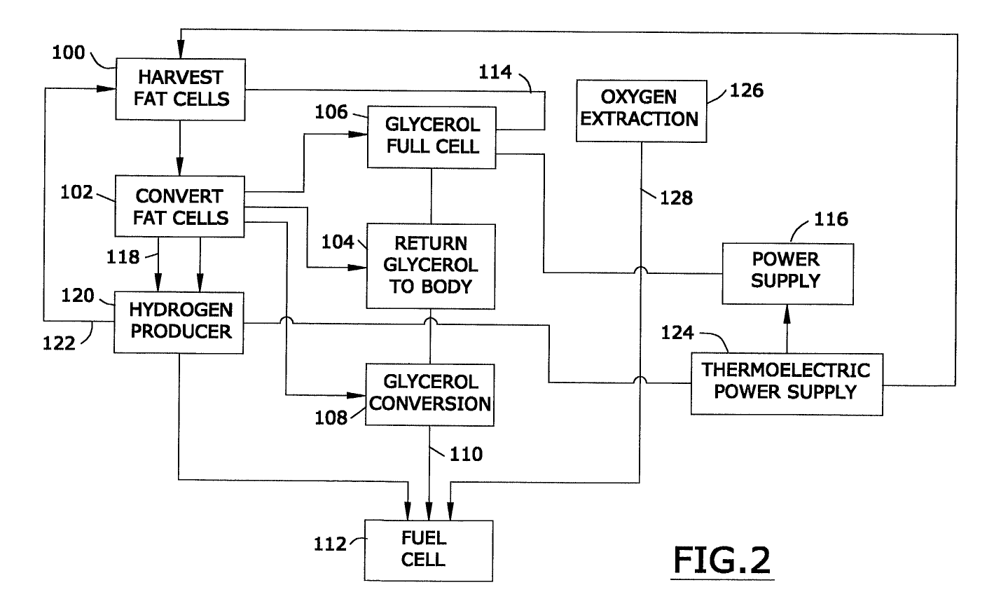

FIG. 2 is a flow diagram of one preferred process of the invention. In step 100 of this process, fat cells are harvested, preferably from fat disposed beneath a person's skin. In step 102 of the process, the harvested fat cells are converted to fatty acids and glycerol. In optional step 104 of the process, some or all of the glycerol so produced is returned to living organism. In step 106 of the process, some or all of the glycerol is fed to a glycerol fuel cell. In step 108 of the process, some or all of the glycerol is converted to hydrogen which, after its production, may be fed via line 110 to fuel cell 112.

To the extent electrical energy is produced in step 106, it may be furnished to fat harvester 100 (via line 114), and/or it may be furnished to a power supply 116, and/or it may be supplied to one or more other loads (not shown), such as a pacemaker, an artificial heart, and the like.

Referring again to FIG. 2, the fatty acids produced in step 102 may be fed via line 118 to the hydrogen producer 120. As indicated elsewhere in this specification, and in one preferred embodiment, hydrogen is produced from the fatty acids by the use of beta-oxidases (to produce acetyl coenzyme A). In one embodiment, oxaloacetate is initially disposed within the chamber 58). Thereafter, the addition of the acetayl coenzyme A facilitates the citric acid cycle, which not only produces hydrogen, but also thermal energy. Referring again to FIG. 2, some or all of the thermal energy may be fed either to harvester 100 (via line 122), and/or thermoelectric power supply 124. The output from thermoelectric power supply 124 may be fed to power supply 116 and/or fat harvester I 00.

Referring again to FIG. 2, and in the preferred embodiment depicted therein, in step 126 oxygen is extracted from one or more bodily fluids and fed to fuel cell 112 via line 128. The fuel cell 112 is preferably a proton exchange membrane fuel cell, as described above.

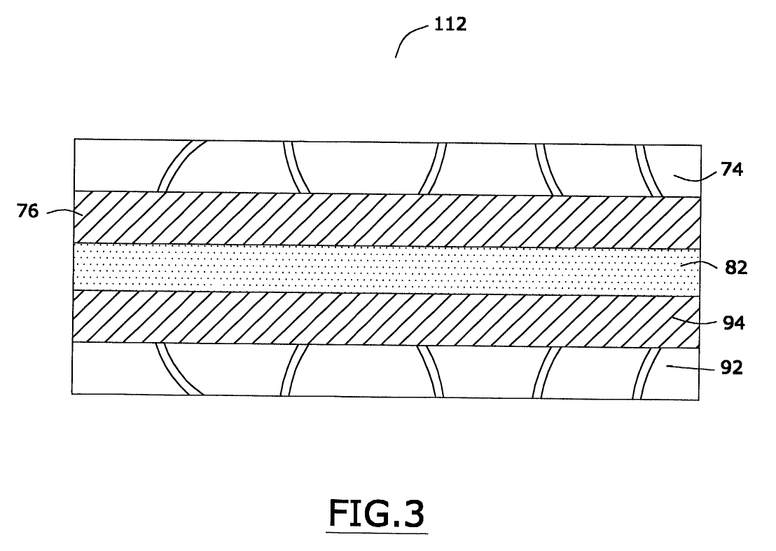

FIG. 3 is a schematic view of a portion of the fuel cell assembly 10 illustrated in FIG. 1, better illustrating fuel cell 112. Referring to FIG. 3, fuel cell 112 is comprised of electrolyte 82. Electrolyte 82 preferably is a dense material that preferably conducts protons. In one preferred embodiment, electrolyate 82 is a perfluorinated polymeric product sold by the E.I. duPont deNemours Company of Wilmington, Del. as “Nafion Membranes NE-112, NE-1135, N-115, and N-117.” These Nafion membranes are non-reinforced films based upon a perflourosulfonic acid/PTFE copolymer in the acid form; and they perform as a separator by selectively transporting cations across a cell junction. Reference may be had, e.g., to U.S. Pat. Nos. 6,319,293, 4,865,925, 6,238,534, 6,040,077, 4,219,394, and the like. The entire disclosure of each of these United States patents is hereby incorporated by reference into this specification.

Referring again to FIG. 3, fuel cell catalyst may be loaded onto the electrolyte 82. When such catalyst is utilized, it preferably is finely-divided platinum particles with an average particle size smaller than about 1 micron.

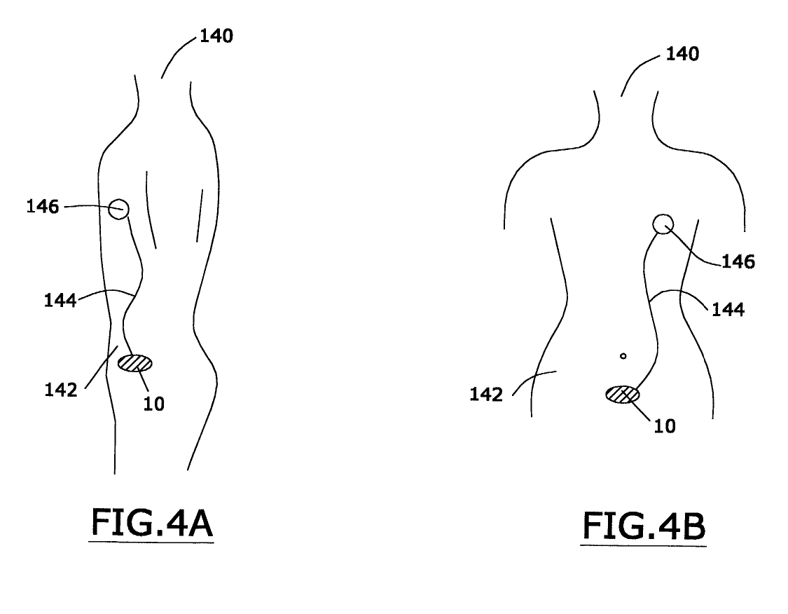

FIGS. 4A and 4B are side and front views, respectively, of patient 140 beneath whose skin 142 is disposed the fuel cell assembly 10 (see FIG. 1). In the preferred embodiment depicted, the fuel cell assembly is connected via line 144 to a pacemaker 146.

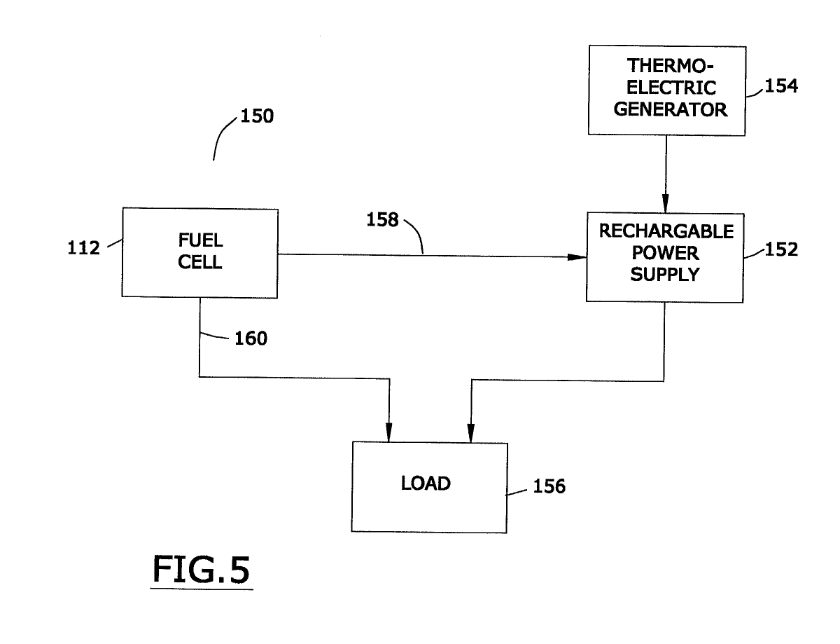

FIG. 5 is a schematic of one preferred power distribution scheme 150. In the device depicted in FIG. 5, rechargeable power supply 152 is fed energy by fuel cell 112 and thermoelectric generator 154. The rechargeable power supply 152 is adapted to store energy, to convert energy, and/or to deliver energy to one or more loads, such as load 156. In addition to furnishing energy to the power supply via line 158, the fuel cell 112 may also furnish some or all of its energy directly to the load 156 via line 160.

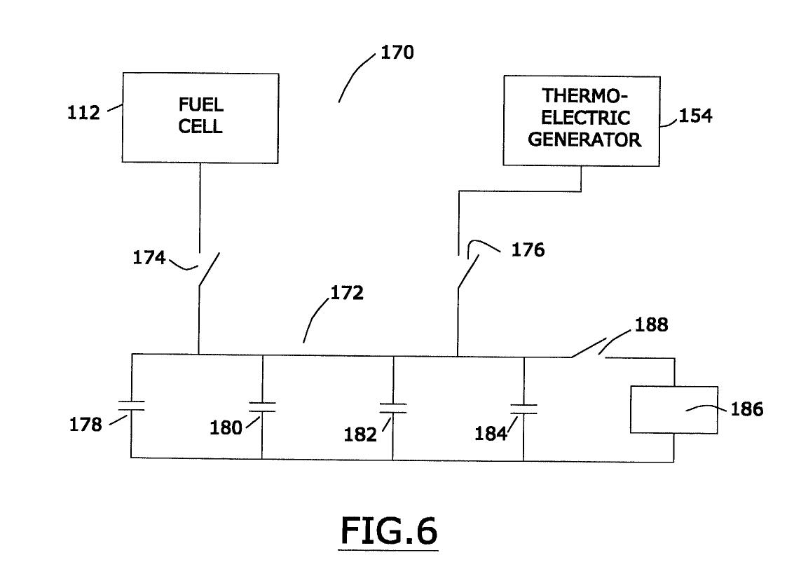

FIG. 6 is a schematric representation of one preferred power storage device 170. Referring to FIG. 6, fuel cell 112 and/or thermoelectric generator 154 deliver power to storage device 172, via switches 174 and/or 176. The power is fed to the bank of capacitors 178, 180, 182, and 184. As is known to those skilled in the art, the amperages in the capacitors in parallel are additive. Thus, one may choose to release a high-current energy supply from the capacitor assembly 172. This high energy supply may be fed to a power supply 186 via switch 188; the power supply 186 preferably is adapted to provide a range of direct or alternating current outputs.

In another embodiment, not shown, the capacitors 178, 180, 182, and/or 184 are connected in series, thus allowing one to produce a high voltage output. In yet another embodiment, some of such capacitors are connected in series, and others of such capacitors are connected in parallel.

FIG. 7 is a schematic of a diagram similar to that illustrated in FIG. 3 of U.S. Pat. No. 5,519,312, the entire disclosure of which is hereby incorporated by reference into this specification. As is disclosed in such patent, by reference to FIG. 3, thereof, “. . . FIG. 3 is a schematic of one preferred fuel cell/SMES hybrid system 10. Referring to FIG. 3, the fuel cell is indicated as element 12 by the symbol for a battery. Direct current power flows from fuel cell 12 in the direction of arrow 34 through smoothing coil 36 which smooths the output of such power; in one preferred embodiment, coil 36 has an inductance of 1 millihenry. The smoothed direct current flowing out of coil 36 may be split between branch 38 and branch 40. When switch 42, which may be a gate turn off thyristor, allows current to pass through it, current is returned to fuel cell 12; in this case, branch 38 presents the path of least resistance. Current limiting resistor 44 prevents an excessive amount of current from flowing into fuel cell 12. As will be apparent to those skilled in the art, the controller 32 (not shown in FIG. 3, but see FIG. 2) is connected to the gate 43 of each of the gate turn off thyristors 42, 45, 47, and 49 in the system and independently controls whether each of such switches is on or off. Alternatively, when switch 42 does not allow current to pass through it, it will flow through power diode 46 and reaches juncture point 48, where it can flow in either branch 50 or branch 52. As before, the gate turn off thyristors 45 and 49 dictate which of branches 50 and 52, if any, the current will flow in. Referring again to FIG. 3, current passing through branch 50 will flow to load 22. Current passing through branch 52, if it is allowed to pass through switch 45, will flow into SMES device 16, which is depicted in the Figure as being comprised of a coil 54, and a switch 56.”

“When the controller (not shown) chooses to charge SMES 16, then current is caused to flow through lines 58, 60, and 62 to the fuel cell 12 and then back into the SMES 16. When the controller (not shown) chooses to discharge SMES 16, then current is caused to flow through current-smoothing coil 64 and diode 66 to load 22; thereafter, the current will return via line 68 back to the SMES.”

The FIG. 7 of this application differs from the FIG. 3 of U.S. Pat. No. 5,519,312 in that inductors 36 and 64 of such old FIG. 3 have been omitted, SMES 54 has been omitted, and rechargeable battery 190 (see FIG. 7) has been added to the circuit.

It is to be understood that the aforementioned description is illustrative only and that changes can be made in the apparatus, in the ingredients and their proportions, and in the sequence of combinations and process steps, as well as in other aspects of the invention discussed her,in, without departing from the scope of the invention as defined in the following claims.

We claim:

1. An implantable fuel cell assembly comprised of means for converting fat to glycerol and fatty acid, means for converting glycerol to hydrogen, means for converting fatty acid to hydrogen, means for converting a bodily fluid to a gas selected from the group consisting of hydrogen, oxygen, and mixtures thereof, and fuel cell means for producing electricity from hydrogen and oxygen.

2. The implantable fuel cell assembly as recited in claim 1, wherein said implantable fuel cell assembly is disposed beneath the skin of a human being.

3. The implantable fuel cell assembly as recited in claim 2, wherein said implantable fuel cell assembly is disposed near fat cells.

4. The implantable fuel cell assembly as recited in claim 1, wherein said implantable fuel cell assembly is comprised of means for harvesting fat cells.

5. The implantable fuel cell assembly as recited in claim 4, wherein said means for harvesting fat cells is comprised of a microknife.

6. The implantable fuel cell assembly as recited in claim 1, wherein said means for converting said fat to said glycerol and said fatty acids is comprised of a fat-permeable material.

7. The implantable fuel cell assembly as recited in claim 6, wherein said means for converting said fat to said glycerol and said fatty acids is comprised of lipase enzyme.

8. The implantable fuel cell assembly as recited in claim 7, wherein from about 3 to about 10 percent of said lipase enzyme is present, based upon the total mass of said lipase enzyme and said fat.

9. The implantable fuel cell assembly as recited in claim 8, further comprising a porous material with an average pore size of less than about 10 nanometers.

10. The implantable fuel cell assembly as recited in claim 1, wherein said means for converting said fatty acids to hydrogen is comprised of beta oxidase enzyme.

11. The implantable fuel cell assembly as recited in claim 10, wherein said means for converting said fatty acids to hydrogen is comprised of oxaloacetate.

12. The implantable fuel cell assembly as recited in claim 1, further comprising a glycerol fuel cell.

13. The implantable fuel cell assembly as recited in claim 12, wherein said glycerol fuel cell is comprised of an anode and anode enzyme disposed on said anode, wherein said anode is configured and arranged for electroxidizing an anode reductant in the presence of the anode enzyme.

14. The implantable fuel cell assembly as recited in claim 13, wherein said glycerol fuel cell is comprised of a cathode spaced apart from said anode and cathode enzyme disposed on said cathode, wherein said cathode is configured and arranged fro electroreducing a cathode oxidant in the presence of said cathode enzyme.

15. The implantable fuel cell assembly as recited in claim 1, wherein said gas is oxygen.

16. The implantable fuel cell assembly as recited in claim 1, wherein said fuel cell assembly further comprises a rechargeable power supply.

17. The implantable fuel cell assembly as recited in claim 16, wherein said fuel cell assembly further comprises a piezoelectric means for converting electricity into mechanical motion.

18. The implantable fuel cell assembly as recited in claim 16, wherein said fuel cell assembly further comprises electrostrictive means for converting electricity into mechanical motion.
